(19) United States
(12) Patent Application Publication
(10) Pub. No.: US 2022/0188755 A1
(43) Pub. Date: Jun. 16, 2022

(54) Alkaline Hydrolysis Tracking System and Related Methods for Tracking Materials in Alkaline Hydrolysis Processes

(71) Applicant: Companah, LLC, Apex, NC (US)

(72) Inventors: Shannon S. Atkins, Fuquay-Varina, NC (US); Harold E. Atkins, Fuquay-Varina, NC (US)

(21) Appl. No.: 17/549,945

(22) Filed: Dec. 14, 2021

Related U.S. Application Data
(63) Continuation-in-part of application No. 29/761,947, filed on Dec. 14, 2020.
(60) Provisional application No. 63/139,523, filed on Jan. 20, 2021.

(51) Int. Cl. G06Q 10/08; G06K 19/07

(52) U.S. Cl. CPC G06Q 10/087; G06K 19/0723

(57) ABSTRACT

Methods for tracking biological material to ensure proper identification of the biological material after undergoing an alkaline hydrolysis process are provided. The method includes associating biological material with a readable electronic mechanism that includes unique identification information associated with the biological material. The readable electronic mechanism is provided to withstand the alkaline hydrolysis process. The method further includes performing the alkaline hydrolysis process on the biological material and obtaining the unique identification information associated with the biological material at at least one point during the alkaline hydrolysis process using a reader configured to communicate with the readable electronic mechanism. A unique electronic record associated with the biological material is updated after obtaining the unique identification information associated with the biological material. The unique electronic record associated with the biological material is made available to users upon request for information related to the biological material.

### CLAIM OF PRIORITY

The present application is a continuation-in-part application of U.S. Design Patent application Ser. No. 29/761,947, filed Dec. 14, 2020 and claims the benefit of and priority to U.S. Provisional Patent application Ser. No. 63/139,523, filed on Jan. 20, 2021, the disclosures of which are incorporated herein by reference as if set forth in their entirety.

### FIELD

The present inventive concept relates generally to alkaline hydrolysis processes, and more particularly, to alkaline hydrolysis tracking systems and methods for tracking materials in alkaline hydrolysis processes.

### BACKGROUND

Alkaline hydrolysis is a chemical process that is used to reduce and sterilize biological matter/material. It is used to safely dispose of biomedical waste, tissue used in laboratories, and in “cremation” of humans and animals. The alkaline hydrolysis “cremation” process is considered to be more environmentally friendly or “green” than a cremation by a burning process in that toxins are not released into the air environment. The alkaline hydrolysis cremation process biochemically hydrolyzes all of the human or animal tissue leaving only the bone fragments behind.

Current methods for tracking subjects of the animal cremation processes include manually tracking subjects through the alkaline hydrolysis process. For example, the subjects may be tracked through the alkaline hydrolysis cremation process by handwritten means, which may not be reliable and may be prone to error. A metal tag with an inscribed number may be attached to the subjects of the alkaline hydrolysis cremation process. However, the metal tag must be inspected and read manually through the process, which again may not provide reliable results. Consequently, there is a desire to develop more automated and reliable methods of tracking biological material through any alkaline hydrolysis processes.

### SUMMARY

Some embodiments of the present inventive concept provide methods for tracking biological material to ensure proper identification of the biological material after undergoing an alkaline hydrolysis process. The method includes associating biological material with a readable electronic mechanism that includes unique identification information associated with the biological material. The readable electronic mechanism is provided to withstand the alkaline hydrolysis process. The method further includes performing the alkaline hydrolysis process on the biological material and obtaining the unique identification information associated with the biological material at at least one point during the alkaline hydrolysis process using a reader configured to communicate with the readable electronic mechanism. A unique electronic record associated with the biological material is updated after obtaining the unique identification information associated with the biological material. The unique electronic record associated with the biological material is made available to users upon request for information related to the biological material.

In further embodiments, obtaining the unique identification information associated with the biological material may include obtaining the unique identification information associated with the biological material multiple times during the alkaline hydrolysis process. Updating may be followed by determining if the alkaline hydrolysis process is complete and repeating the obtaining and updating until it is determined that alkaline hydrolysis process is complete.

In still further embodiments, determining if the alkaline hydrolysis process is complete may be followed by storing a final electronic record associated with the biological material.

In some embodiments, the readable electronic mechanism may be provided to withstand the alkaline hydrolysis process by one of providing a protective coating around the readable electronic mechanism and providing the readable electronic mechanism inside an enclosure such that the readable electronic mechanism withstands the alkaline hydrolysis process.

In further embodiments, associating biological material with a readable electronic mechanism may include one of attaching the readable electronic mechanism to the biological material or positioning the readable electronic mechanism close to biological material being processed.

In still further embodiments, associating biological material with a readable electronic mechanism may be preceded by positioning the biological material in semi-permeable enclosure before performing the alkaline hydrolysis process and wherein the readable electronic mechanism is also positioned in the semi-permeable enclosure.

In some embodiments, the readable electronic mechanism may include a radio-frequency identification (RFID) tag.

In further embodiments, the biological material may include human remains, animal remains, and/or biomedical waste.

In still further embodiments, the unique identification information may include a unique ID number; information about the biological material; information about an owner of the biological material; information about origination of the biological material; and/or information about type of biological material.

In some embodiments, making the unique electronic record associated with the biological material available to users upon request for information related to the biological material may include providing a graphical user interface that allows users to obtain information from the unique electronic record associated with the biological material before, during and after the alkaline hydrolysis process.

Related systems are also provided.

### BRIEF DESCRIPTION OF THE DRAWINGS

Reference will now be made to the accompanying drawings, which are not necessarily drawn to scale, and wherein:

FIG. 1 is a block diagram illustrating an alkaline hydrolysis tracking system for tracking materials in alkaline hydrolysis processes in accordance with some embodiments of the present inventive concept.

FIG. 2 is a flowchart illustrating methods of using the alkaline hydrolysis tracking system of FIG. 1 for tracking materials in alkaline hydrolysis processes in accordance with some embodiments of the present inventive concept.

FIG. 3 is a block diagram illustrating an animal cremation tracking system in accordance with some embodiments of the present inventive concept.

FIG. 4 through FIG. 9B are diagrams illustrating various views of RFID tag enclosures (cameos) suitable to tolerate alkaline hydrolysis processes in accordance with some embodiments of the present inventive concept.

FIG. 10 is a user interface illustrating the animal cremation tracking system of FIG. 3 in accordance with some embodiments of the present inventive concept.

FIG. 11 is a flowchart illustrating methods of using the animal cremation tracking system of FIG. 3 for tracking materials in alkaline hydrolysis processes in accordance with some embodiments of the present inventive concept.

### DETAILED DESCRIPTION

The present inventive concept now will be described more fully hereinafter with reference to the accompanying drawings, in which some, but not all embodiments of the present inventive concept are shown. Like numbers refer to like elements throughout. The present inventive concept may be embodied in many different forms and should not be construed as limited to the embodiments set forth herein; rather, these embodiments are provided so that this disclosure will satisfy applicable legal requirements. Indeed, many modifications and other embodiments of the present inventive concept set forth herein will come to mind to one skilled in the art to which the present inventive concept pertains having the benefit of the teachings presented in the foregoing descriptions and the associated drawings. Therefore, it is to be understood that the present inventive concept is not to be limited to the specific embodiments disclosed and that modifications and other embodiments are intended to be included within the scope of the appended claims.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the present inventive concept. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. As used herein the term “and/or” includes any and all combinations of one or more of the associated listed items and may be abbreviated as “/”.

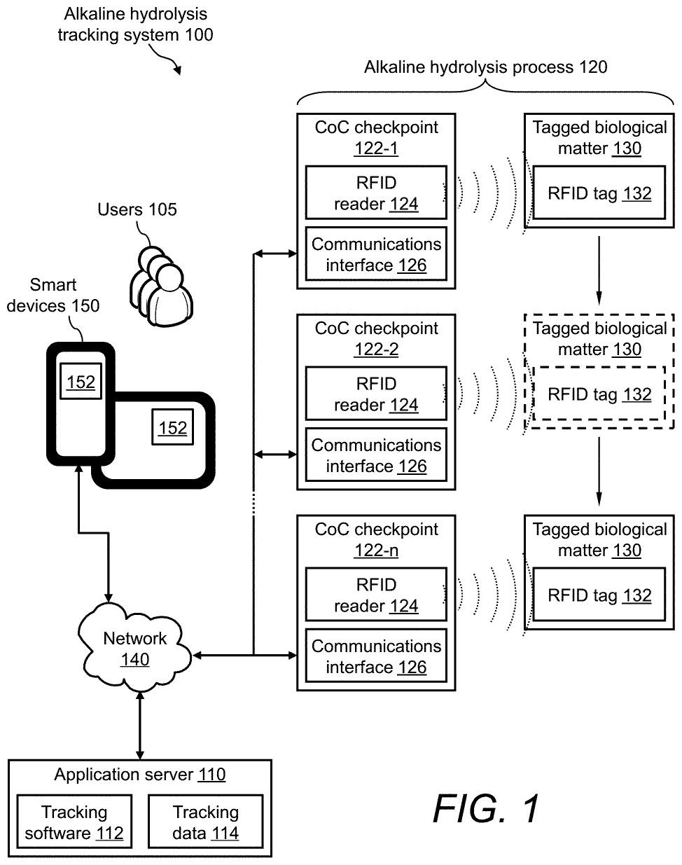

Referring now to FIG. 1, a block diagram illustrating an alkaline hydrolysis tracking system 100 for tracking materials in alkaline hydrolysis processes in according to some embodiments of the present inventive concept will be discussed. It will be understood that the alkaline hydrolysis tracking system 100 may be suitable for tracking any type of biological material in any type of alkaline hydrolysis process. For example, the alkaline hydrolysis tracking system 100 may be suitable for use in tracking human and/or animal remains through alkaline hydrolysis cremation, tracking biomedical waste being sterilized and disposed through alkaline hydrolysis, tracking biomedical waste being disposed through alkaline hydrolysis tissue digesters, and the like.

As used herein, “biological materials” (or matter) include, but are not limited to, human and animals, including, but not limited to, parts thereof, tissues, organs, blood, bodily fluids, clinical specimens; pathogenic microorganisms (including human, animal, or plant pathogens); plants; insects; microorganisms, or cells that produce toxic compounds; recombinant or synthetic DNA/RNA (plasmids, cloned materials, oligonucleotides, siRNA); viral vectors (e.g., lentivirus, retrovirus, adenovirus, AAV) and genetically-modified organisms (animals, microorganisms, plants, insects, cells/cell lines).

“Biological waste” that can be tracked includes, but is not limited to, waste created from use of the biological materials noted above. Further non-limiting examples of biological waste include, but are not limited to, blood and blood products, pathological waste, cultures and stocks of infectious agents and associated biologicals, contaminated animal carcasses and bedding, and biotechnology by-product effluents (i.e., recombinant DNA, vectors, etc.) as well as various chemicals or radiological materials mixed with the same.

“Human remains” include those of individuals of all races or ethnicities, including, but not limited to, Caucasian, African-American, African, Asian, Hispanic, Indian, etc., and combined backgrounds. The subjects may be of any age, including newborn, neonate, infant, child, adolescent, adult, and geriatric. Animal remains may be those of canines, felines, bovines, caprines, equines, ovines, porcines, rodents (e.g. rats and mice), lagomorphs, primates (including non-human primates), etc., including domesticated animals, companion animals and wild animals for veterinary medicine, treatment or pharmaceutical drug development purposes.

Referring again to FIG. 1, the alkaline hydrolysis tracking system 100 includes an application server 110 that further includes certain tracking software 112 and tracking data 114. Application server 110 may be, for example, any networked, centralized, and/or cloud-based server. The alkaline hydrolysis tracking system 100 may also include an alkaline hydrolysis process 120 that may include a plurality of chain of custody (CoC) checkpoints 122. Alkaline hydrolysis process 120 may be representative of any alkaline hydrolysis process, such as, but not limited to, human and/or animal alkaline hydrolysis cremation, sterilization and disposal of biomedical waste using alkaline hydrolysis, disposal of biomedical waste using alkaline hydrolysis tissue digesters, and the like. Further, CoC checkpoints 122 may be representative of any process steps of any of the aforementioned alkaline hydrolysis processes. Alkaline hydrolysis process 120 may include any number of CoC checkpoints 122, in order from, for example, CoC checkpoints 122-1 through 122-n.

In some embodiments of the present inventive concept, the alkaline hydrolysis process may include 95% KOH and 5% NaOH as base for alkaline hydrolysis process. This particular formulation may provide increased viability of the device, quicker drying of remains, and reduction of unwanted residue.

In some embodiments, an industrial degreaser liquid may be injected during the alkaline hydrolysis process. Injection of the industrial degreaser may also provide increased viability of the device, quicker drying of remains, and reduction of unwanted residue.

Alkaline hydrolysis process 120 may be used to process certain biological matter. With respect to tracking the CoC of any biological matter being processed through the CoC checkpoints 122 (i.e., process steps) of alkaline hydrolysis process 120, a readable electronic identification mechanism may be attached to or accompany the biological matter being processed. The readable electronic identification mechanism may include “unique identification information” associated with the biological matter. The “unique identification information” may include a unique ID number, information about the type of biological material, who the biological material belongs to and the like. In some embodiments, the unique identification information may include information obtained from a microchip associated with the biological material.

For example, the biological material being processed may be tracked using RFID technology. In some embodiments, tagged biological matter 130 is provided that has an attached or at least accompanying RFID tag 132. That is, in the alkaline hydrolysis tracking system 100 each instance of biological matter being processed is an instance of tagged biological matter 130 having an RFID tag 132 holding electronically stored information (unique identification information), such as a unique ID number. In addition to the unique ID number, the stored information may include other information about the biological matter being processed, such as the owner and/or origination of the biological matter, the type of biological matter, and the like.

As illustrated in FIG. 1, in embodiments where the readable electronic mechanism is an RFID tag, an RFID tag 132 may be associated with the biological matter 130. For example, in some embodiments, the biological matter 130 may be tagged with a passive RFID tag that has no power supply and relies on RF energy transferred from an RFID reader to extract the stored information. For example, each of the CoC checkpoints 122-1 through 122-n illustrated in FIG. 1 may include an RFID reader 124. RFID reader 124 can be any standard RFID reader device for scanning the contents of an RFID tag, such as the RFID tag 132 of the respective tagged biological matter 130. In particular, RFID reader 124 may be used to read the unique identification information, for example, the unique ID number and/or any other information, of any tagged biological matter 130.

It will be understood that although embodiments discussed above with respect to FIG. 1 discuss a passive RFID tag, embodiments are not limited thereto. RFID tags that both receive and transmit information may be used without departing from the scope of the present inventive concept.

Each of the CoC checkpoints 122-1 through 122-n may include a communications interface 126 that may be used to exchange information with application server 110 via a network 140. Network 140 may be, for example, a local area network (LAN), a wide area network (WAN), and/or a cellular network for connecting to the Internet or to an Intranet.

The communications interface 126 of the CoC checkpoints 122 may be any wired and/or wireless communication interface for connecting to network 140 and by which information may be exchanged with other devices connected to network 140. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+(Advanced Network Tools) technology, radio frequency (RF), near-field communication (NFC), Infrared Data Association (IrDA) compatible protocols, Local Area Networks (LAN), Wide Area Networks (WAN), Shared Wireless Access Protocol (SWAP), any combinations thereof, and other types of wireless networking protocols.

Certain users 105 may be associated with the alkaline hydrolysis tracking system 100 that includes the alkaline hydrolysis process 120. The users 105 may be any parties interested in tracking instances of tagged biological matter 130 through the alkaline hydrolysis process 120. Examples of the users 105 may include, but are not limited to, system administers, any owners and/or providers of tagged biological matter 130, any operators of any of the CoC checkpoints 122-1 through 122-n of alkaline hydrolysis process 120, and the like.

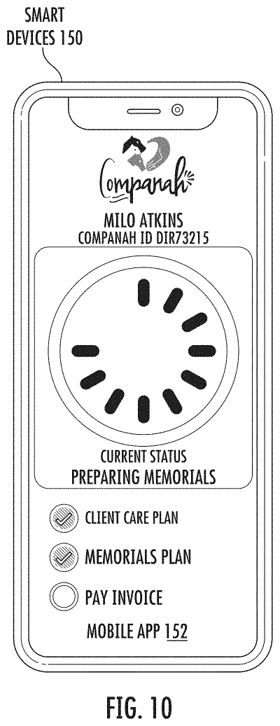

Each of the users 105 may use a smart device 150 to access the alkaline hydrolysis tracking system 100. Smart devices 150 may be, for example, desktop computers, laptop computers, tablet devices, mobile phones or smartphones, smart watches, and the like. A graphical user interface (GUI) 152 may be provided on smart devices 150. In some embodiments, tablet devices, mobile phones or smartphones, and/or smart watches, the GUI 152 may be implemented by a mobile application 152 running on the device. In further embodiments, on desktop and/or laptop computers, the GUI 152 may be a desktop application 152. An example of a mobile application 152 is shown hereinbelow with reference to FIG. 10.

In some embodiments, a single tap device registration using, example, an near field communication (NFC) embedded chip may be implemented. The RFID tag that may be provided in an enclosure (“cameo”) may be registered to the biological material via electronic devices, such as a phone, and could be done by, for example, a crematory, pet owner or veterinarian without departing from the scope of the present inventive concept.

In the alkaline hydrolysis tracking system 100, at each CoC checkpoint 122, the RFID reader 124 may be used to scan the unique information associated with the RFID tag 132 of any instance of tagged biological matter 130 passing therethrough. For example, for any instance of tagged biological matter 130, the RFID tag 132 may be scanned upon entering a certain CoC checkpoint 122 and then scanned again upon exiting the certain CoC checkpoint 122. In these embodiments, two records of information may be provided at each CoC checkpoint 122 and these two records may be transmitted to application server 110, processed by tracking software 112, and stored in tracking data 114.

In the alkaline hydrolysis tracking system 100, any RFID tag 132 of any tagged biological matter 130 may be provided in a manner suitable to tolerate the processing conditions and/or environment of alkaline hydrolysis process 120. Generally, an alkaline hydrolysis process is a heated liquid environment with high alkalinity and operating under pressure. For example, alkaline hydrolysis process 120 may a heated liquid environment operating at about 205° F. with a pH of about 12 and at about atmospheric pressure, noting that with added pressure, for example, up to 65 pound per square inch (PSI), temperature can raise to about 300° F.

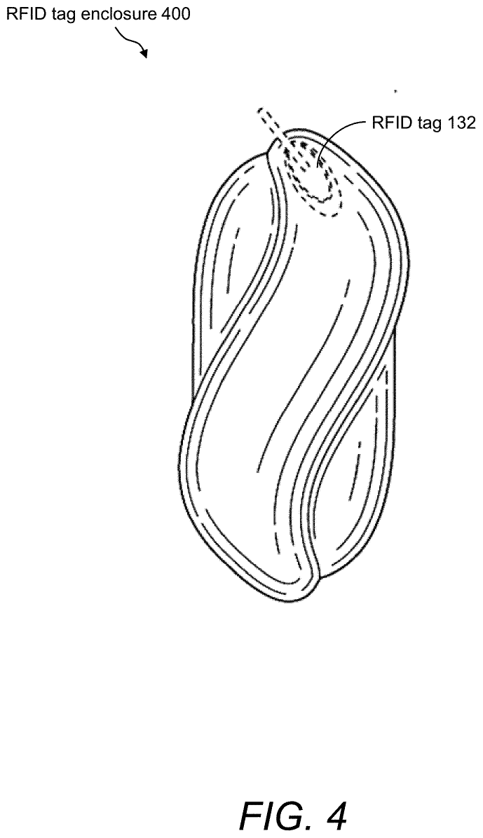

Thus, the RFID tag 132 is configured to tolerate these processing conditions. For example, in some embodiments, the RFID tag 132 may include a protective coating, such as a ceramic coating, thereon to protect the tag during the process. In further embodiments, the RFID tag 132 may be provided inside an enclosure (cameo) that is configured to protect the tag during the process. Embodiments of the present inventive concept providing an enclosure suitable to protect an RFID tag in an alkaline hydrolysis process are discussed below with reference to FIG. 4 through FIG. 9B.

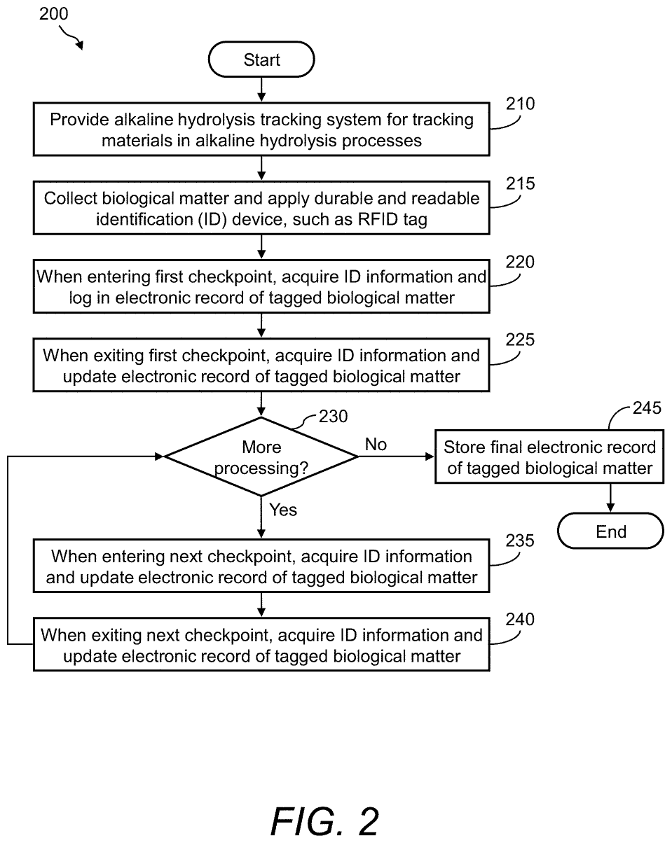

Referring now to FIG. 2, a flowchart illustrating methods 200 of using the alkaline hydrolysis tracking system 100 shown in FIG. 1 for tracking materials in alkaline hydrolysis processes in accordance with some embodiments of the present inventive concept will be discussed. Method 200 may be used to track and create a validated chain of custody of biological matter throughout any alkaline hydrolysis process. As used herein, “chain of custody (CoC)” refers to the chronological documentation (e.g., physical or electronic) that records the sequence of custody of biological matter through any or all points of an alkaline hydrolysis process including, but not limited to, from point of origin to delivery of the same to family, relatives, friends, pet owners, veterinary offices, laboratories or other parties or organizations of interest. For example, throughout the steps of method 200, the users 105 may use their smart devices 150 (with GUI 152) to monitor and/or track the progress of any tagged biological matter 130 of interest as it progresses through alkaline hydrolysis process 120 of the alkaline hydrolysis tracking system 100. Method 200 may include, but is not limited to, the following steps.

As illustrated in FIG. 2, the method begins at block 210 by providing an alkaline hydrolysis tracking system for tracking materials in alkaline hydrolysis processes. For example, the system may be the alkaline hydrolysis tracking system 100 of FIG. 1 and may be provided for tracking tagged biological matter 130 via RFID tags 132 and RFID readers 124 in alkaline hydrolysis process 120.

Biological matter is collected and then a durable and readable ID device, such as an RFID tag, is applied to or accompanies the biological matter (block 215). For example and referring to FIG. 1, biological matter is collected and then tagged with a durable and readable RFID tag 132 to form tagged biological matter 130.

When entering the first checkpoint of the alkaline hydrolysis process, the ID information of the tagged biological matter is acquired and then logged in an electronic record (block 220). For example and referring to FIG. 1, when entering CoC checkpoint 122-1 of alkaline hydrolysis process 120, the ID information in RFID tag 132 of tagged biological matter 130 is acquired and then transmitted to tracking software 112 at application server 110. Then, for the tagged biological matter 130 of interest, the ID information is logged in an electronic record at tracking data 114.

In some embodiments, the ID information may include information obtained from a microchip that is scanned upon intake of the biological matter, for example, a pet. The information from the microchip may be combined with other information to create a unique tracking ID for the biological material.

When exiting the first checkpoint of the alkaline hydrolysis process, the ID information of the tagged biological matter is acquired and then the electronic record is updated (block 225). For example and referring to FIG. 1, when exiting CoC checkpoint 122-1 of alkaline hydrolysis process 120, the ID information in RFID tag 132 of tagged biological matter 130 is acquired and then transmitted to tracking software 112 at application server 110. Then, for the tagged biological matter 130 of interest, the electronic record in tracking data 114 is updated.

It is determined whether more processing is needed in the alkaline hydrolysis process for the biological matter of interest (block 230). For example and referring to FIG. 1, it is determined whether more processing is needed in alkaline hydrolysis process 120 for the tagged biological matter 130 of interest. That is, it is determined whether the tagged biological matter 130 of interest needs further processing at other downstream CoC checkpoints 122 of alkaline hydrolysis process 120.

If more processing of the biological matter of interest is needed, then operations proceed to step 235. However, if more processing of the biological matter of interest is not needed, then operations proceed to step 245 where the final electronic record of the tagged biological material is stored.

At a step 235, when entering the next checkpoint of the alkaline hydrolysis process, the ID information of the tagged biological matter is acquired and then logged in an electronic record. For example and referring to FIG. 1, when entering the next CoC checkpoint 122 (e.g., 122-2, 122-3, to 122-n) of alkaline hydrolysis process 120, the ID information in RFID tag 132 of tagged biological matter 130 is acquired and then transmitted to tracking software 112 at application server 110. Then, for the tagged biological matter 130 of interest, the electronic record in tracking data 114 is updated.

When exiting the next checkpoint of the alkaline hydrolysis process, the ID information of the tagged biological matter is acquired and then the electronic record is updated (block 240). For example and referring to FIG. 1, when exiting the next CoC checkpoint 122 (e.g., 122-2, 122-3, to 122-n) of alkaline hydrolysis process 120, the ID information in RFID tag 132 of tagged biological matter 130 is acquired and then transmitted to tracking software 112 at application server 110. Then, for the tagged biological matter 130 of interest, the electronic record in tracking data 114 is updated. Operations return to block 230 to determine if more processing is needed and operations of blocks 230 through 240 repeat until it is determined that no more processing is needed.

At a step 245, the final electronic record of the tagged biological matter of interest is logged. For example and referring to FIG. 1, the final electronic record of the tagged biological matter 130 of interest is logged in tracking data 114 at application server 110.

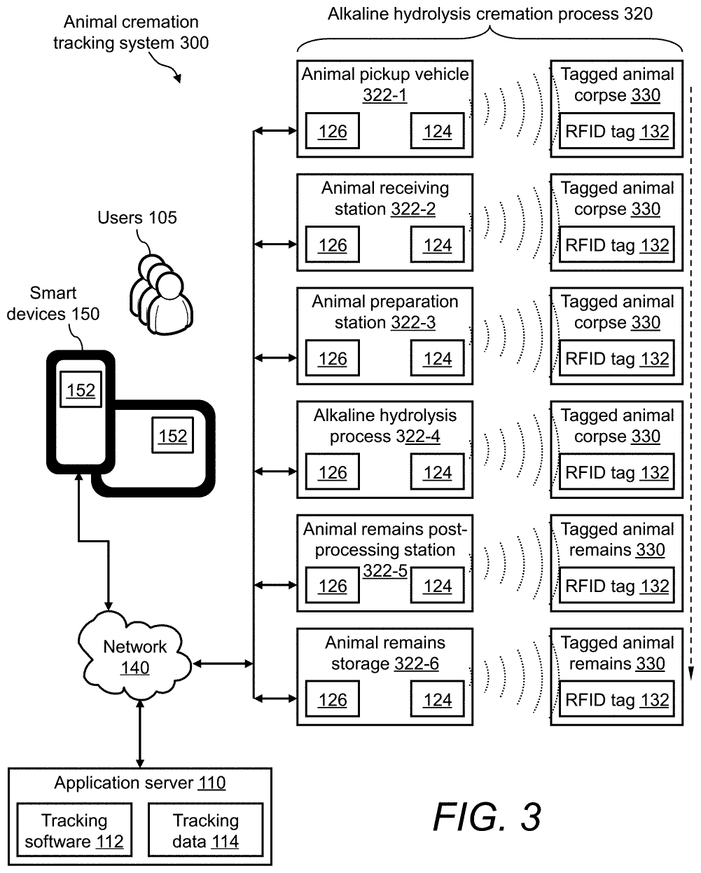

Referring now to FIG. 3, a block diagram of an animal cremation tracking system 300, which is one example of the alkaline hydrolysis tracking system 100 shown in FIG. 1, will be discussed. The animal cremation tracking system 300 includes application server 110 with tracking software 112 and tracking data 114, and network 140 as discussed with reference to the alkaline hydrolysis tracking system 100 shown in FIG. 1.

The animal cremation tracking system 300 further includes an alkaline hydrolysis cremation process 320, which may be, for example, a pet cremation process. The alkaline hydrolysis cremation process 320 is a specific example of alkaline hydrolysis process 120 of the alkaline hydrolysis tracking system 100 shown in FIG. 1. In these embodiments, the alkaline hydrolysis cremation process 320 may be used to process a tagged animal corpse 330 including a RFID tag 132.

The alkaline hydrolysis cremation process 320 may include a sequence of process steps 322 (e.g., process steps 322-1 through 322-n) that are examples of CoC checkpoints 122 shown in FIG. 1 at which tagged biological matter 130 may be tracked. For example, the alkaline hydrolysis cremation process 320 may include in order an animal pickup vehicle 322-1; an animal receiving station 322-2; an animal preparation station 322-3; an alkaline hydrolysis process 322-4; an animal remains post-processing station 322-5; and an animal remains storage 322-6. Further, each of the animal pickup vehicle 322-1; the animal receiving station 322-2; the animal preparation station 322-3; the alkaline hydrolysis process 322-4; the animal remains post-processing station 322-5; and the animal remains storage 322-6 include an RFID reader 124 and a communications interface 126 as discussed with respect to FIG. 1. It will be understood that the alkaline hydrolysis cremation process 320 is not limited to the process steps 322 shown in FIG. 3, these are provided for example only.

An animal cremation tracking system 300 including the alkaline hydrolysis cremation process 320 may be used to support a pet cremation service to customers. For example, in the animal cremation tracking system 300, the users 105 may be pet owners 105, veterinarians 105, and any operational workers 105 (e.g., pickup drivers 105, workers 105) related to the alkaline hydrolysis cremation process 320. In these embodiments, the tagged animal corpse 330 may be the deceased pet of a pet owner. Sometimes a veterinarian may be involved in the loss of a pet. Again, the users 105 may use their smart devices 150 (with GUI 152) to monitor and/or track the progress of any tagged animal corpse 330 of interest as it progresses through the alkaline hydrolysis cremation process 320 of the animal cremation tracking system 300.

The animal pickup vehicle 322-1 of the alkaline hydrolysis cremation process 320 may be, for example, any vehicle that may be used to retrieve an animal corpse. The driver of the animal pickup vehicle 322-1 is an example of a user 105—pickup driver 105. The pickup driver 105 of the animal pickup vehicle 322-1 may collect the animal corpse. Then, the pickup driver 105 may apply an RFID tag 132 to the animal corpse to form a tagged animal corpse 330. Then, the pickup driver 105 may use the RFID reader 124 in the animal pickup vehicle 322-1 to scan tagged animal corpse 330. In so doing, an electronic record of the tagged animal corpse 330 of interest is created in the tracking data 114 at the application server 110. Again, RFID tag 132 of the tagged animal corpse 330 may be provided in an enclosure suitable to protect it in the alkaline hydrolysis cremation process 320 (see FIG. 4 through FIG. 9B).

The animal receiving station 322-2 may be a designated area of the alkaline hydrolysis cremation process 320 for receiving the tagged animal corpse 330 of interest from the animal pickup vehicle 322-1. Again, here a worker 105 may use RFID reader 124 to scan the tagged animal corpse 330 and its electronic record in tracking data 114 is updated.

The animal preparation station 322-3 may be a designated area of the alkaline hydrolysis cremation process 320 for preparing the tagged animal corpse 330 for the alkaline hydrolysis cremation process. Again, here a worker 105 may use RFID reader 124 to scan the tagged animal corpse 330 and its electronic record in tracking data 114 is updated.

The alkaline hydrolysis process 322-4 is the alkaline hydrolysis process of the alkaline hydrolysis cremation process 320. Again, here a worker 105 may use RFID reader 124 to scan the tagged animal corpse 330 and its electronic record in tracking data 114 is updated.

The animal remains post-processing station 322-5 may be a designated area of the alkaline hydrolysis cremation process 320 for post-processing the now tagged animal remains 330 following the alkaline hydrolysis cremation process. Again, here a worker 105 may use the RFID reader 124 to scan the tagged animal remains 330 and its electronic record in tracking data 114 is updated.

The animal remains storage 322-6 may be a designated area of the alkaline hydrolysis cremation process 320 for storing the now tagged animal remains 330. Again, here a worker 105 may use the RFID reader 124 to scan the tagged animal remains 330 and its electronic record in tracking data 114 is updated.

Once the alkaline hydrolysis process is complete, in some embodiments, the remains may be dried in a climate-controlled ventilation room to isolate the RFID and pet microchip. In some embodiments, the remains may be dried using a freeze-drying dehydrator, however embodiments of the present inventive concept are not limited thereto.

The readable electronic mechanism 132, for example, the RFID tag in some embodiments, may be configured to withstand the alkaline hydrolysis process. For example, in some embodiments, the RFID tag may be coated with a protective material to ensure the RFID tag can withstand the process. For example, in some embodiments the RFID tag may be coated with a ceramic material. In some embodiments, the readable electronic mechanism may be placed inside an enclosure to protect the mechanism during the process. These embodiments will be discussed below with respect to FIGS. 4 through 9.

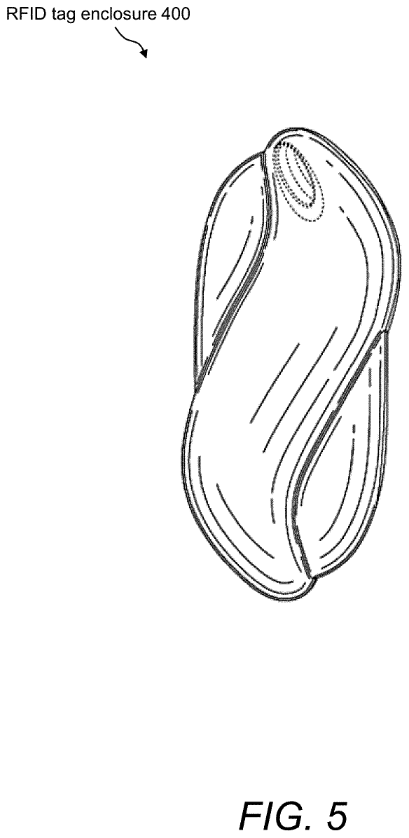

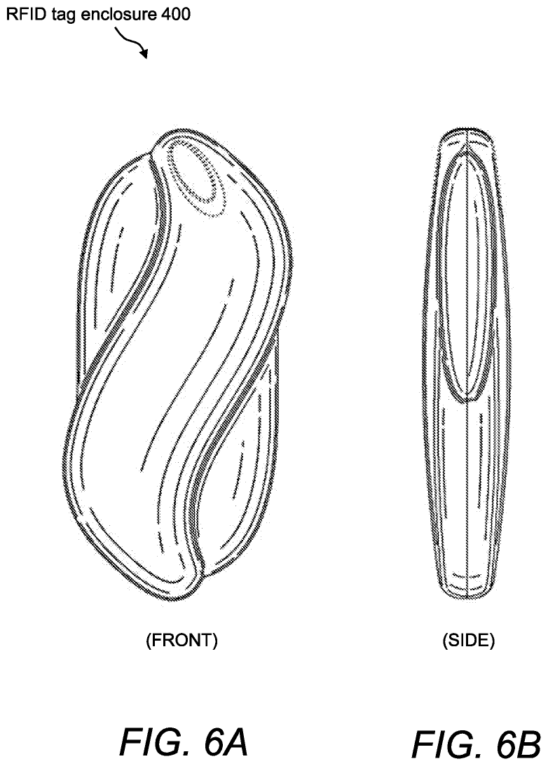

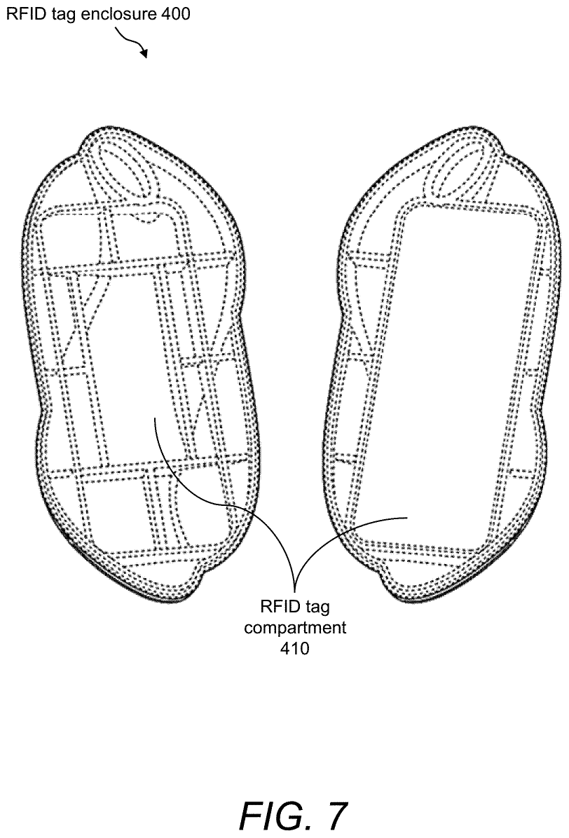

Referring now to FIG. 4 through FIG. 9B, various views of examples of a readable electronic mechanism/RFID tag enclosures 400 suitable to tolerate alkaline hydrolysis processes will be discussed. For example, FIG. 4 shows a plan view, FIG. 5 shows a perspective view, and FIG. 6A shows a front view and FIG. 6B shows a side view of one example of an RFID tag enclosure 400, referred to as a cameo in some embodiments. The RFID tag enclosure 400 may be, for example, a molded plastic enclosure in which an RFID tag, such as the RFID tag 132, may be installed and protected during any alkaline hydrolysis process. In some embodiments, the enclosure 400 may include graphite, carbon black or polymer fibers mixed with base polymers in the material for the injection molding. FIG. 7 shows two halves of the RFID tag enclosure 400 opened and showing an RFID tag compartment 410 for holding the RFID tag 132. Namely, the RFID tag 132 may be placed in the RFID tag compartment 410, then the two halves of the RFID tag enclosure 400 are closed and bonded together. The two halves of the RFID tag enclosure 400 may be bonded, for example, via an adhesive, or by any welding process, such as, but not limited to, thermal welding, ultrasonic welding, solvent welding, and laser welding.

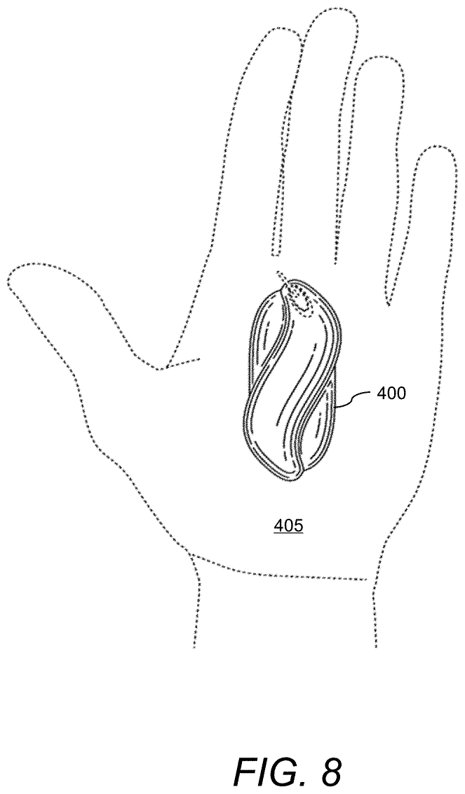

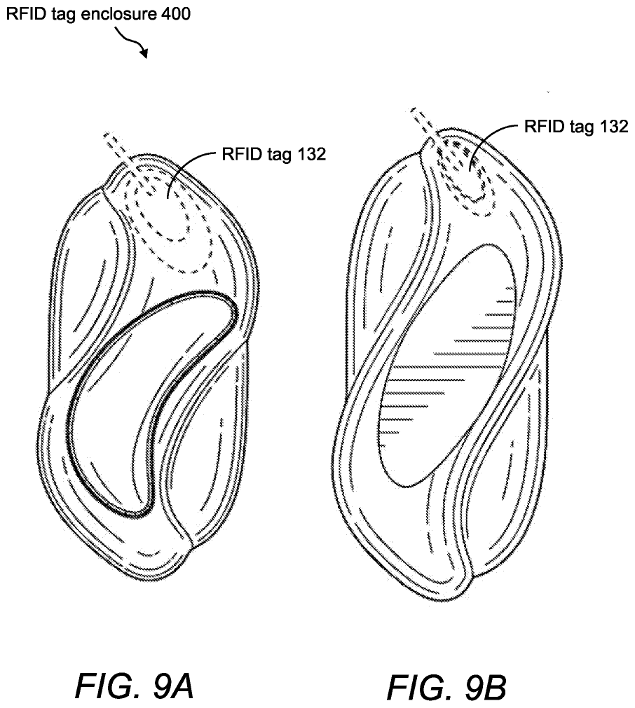

For size perspective, FIG. 8 shows an example of the RFID tag enclosure 400 in relation to a human hand 405. Further, FIGS. 9A and 9B show other examples of RFID tag enclosure 400, perhaps including different esthetics than those shown in FIG. 4. In embodiments of the present inventive concept specific to pet cremation, the RFID tag enclosure 400 may be returned to the owner as a keepsake. In some embodiments, the enclosure device may include at least some of the remains of the subject having undergone the cremation process. In some embodiments, the enclosure device may include, for example, a microchip or other implant device that was previously in the subject and subsequently retrieved from the remains of the subject having undergone the alkaline hydrolysis process.

In some embodiments, the biological material, for example, the deceased pet, the tag enclosure and any other elements of the system are positioned in a semi-permeable mesh enclosure, for example, a nylon semi-permeable mesh enclosure, before performing the alkaline hydrolysis process. The synthetic polymers of the mesh enclosure do not break down during the process and allow the remains, the tag and, for example, the microchip, to be easily located once the process is complete. The mesh enclosure may be a single use mesh enclosure or recyclable without departing from the scope of the present inventive concept. Once a pet is enclosed within the nylon enclosure (along with the RFID tag), it provides a means of safely retaining all pet remains and securing the RFID tag as well. As discussed, within this enclosure, the pet microchip may be recovered.

Referring now to FIG. 10, a plan view of an example of a mobile application 152 of the animal cremation tracking system 300 shown in FIG. 3 will be discussed. The mobile application 152 is one example of the GUI 152 on smart device 150. In these embodiments, the features of the mobile application 152 are specific to a pet cremation system, such as the animal cremation tracking system 300.

For example, with respect to pet owners 105, the mobile application 152 may be used to check status of a pet while in the care of the animal cremation tracking system 300. Status may include, for example, where the pet is in process; the date of return; and the like. The mobile application 152 may also be used by pet owners 105 to order additional memorial products, customize products, and so on. The mobile application 152 may also be used by pet owners 105 to access other resources, such as grief support and pet adoption guidance.

With respect to the veterinarians 105, the mobile application 152 may be used as a service order dashboard. For example, to order service for individual pets, particular method, memorial products. For example, to monitor order status or to order changes. For example, to check status of open service orders (status, date of return, order details), make change requests on open service orders. For example, to order supplies, such as bags, RFID tags, memorial items, and the like.

With respect to the operational workers 105, the mobile application 152 may provide a workflow overview of all pets in care of the animal cremation tracking system 300, a way to prioritize events and perform workload planning, a way to stay apprised of business intelligence rules (e.g., status checks, supply orders), and the like.

With respect to the operational workers 105, the mobile application 152 may provide pet information, such as order details, pet information, and owner information.

With respect to the operational workers 105, the mobile application 152 may provide a way to manage tasks assigned to each employee for the workday. The mobile application 152 may also provide a route planner including an overview of routes in process.

With respect to the pickup drivers 105, the mobile application 152 may provide available routes, a summary of routes that are available to be taken by staff members (distance, number of stops, hours), route info/status/check. For example, for each route claimed by staff person, a list of stops (with check in/check out functionality), and so on.

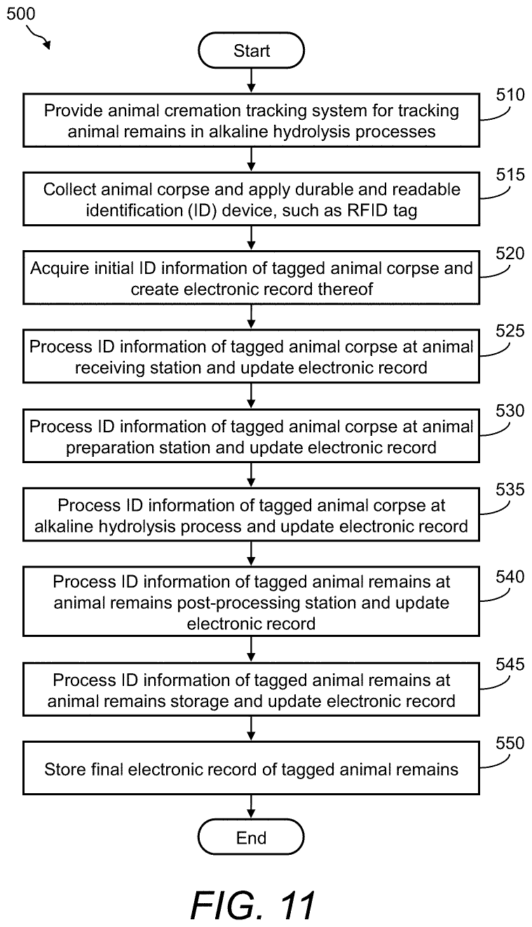

Referring now to FIG. 11, a flowchart illustrating a method 500 of using the animal cremation tracking system 300 shown in FIG. 3 for tracking materials in alkaline hydrolysis processes in accordance with some embodiments of the present inventive concept will be discussed. Method 500 may be used to track and create a validated chain of custody of biological matter throughout any alkaline hydrolysis process. For example, throughout the steps of method 500, the users 105 may use their smart devices 150 (with GUI 152) to monitor and/or track the progress of any tagged animal corpse 330 of interest as it progresses through the alkaline hydrolysis cremation process 320 of the animal cremation tracking system 300. Method 500 may include, but is not limited to, the following steps.

Operations begin at block 510 by providing an animal cremation tracking system for tracking animal remains in alkaline hydrolysis processes. For example, the animal cremation tracking system 300 shown in FIG. 3 may be provided for tracking tagged animal corpse 330 via RFID readers 124 and RFID tags 132 in the alkaline hydrolysis cremation process 320.

Biological matter is collected and then a durable and readable ID device, such as an RFID tag, is applied to the biological matter (block 515). For example and referring to FIG. 3, a pickup driver 105 may use an animal pickup vehicle 322-1 to collect an animal corpse. Then, the pickup driver 105 may apply an RFID tag 132 to the animal corpse to form a tagged animal corpse 330.

The initial ID information of the tagged animal corpse is acquired, and an electronic record of the tagged animal corpse is created (block 520). For example and referring to FIG. 3, using the RFID reader 124, the pickup driver 105 scans RFID tag 132 of tagged animal corpse 330 and an electronic record of the tagged animal corpse 330 of interest is created at tracking data 114 at application server 110.

The ID information of the tagged animal corpse is processed at the animal receiving station and the electronic record of the tagged animal corpse is updated (block 525). For example and referring to FIG. 3, the RFID tag 132 of the tagged animal corpse 330 of interest is scanned when it exits the animal pickup vehicle 322-1. Then, the tagged animal corpse 330 of interest is scanned again when it enters animal receiving station 322-2. Then, the tagged animal corpse 330 of interest is scanned again when it exits animal receiving station 322-2. With each scan event, the electronic record of the tagged animal corpse 330 of interest is updated at tracking data 114 at application server 110.

The ID information of the tagged animal corpse is processed at the animal preparation station and the electronic record of the tagged animal corpse is updated (block 530). For example and referring to FIG. 3, the RFID tag 132 of the tagged animal corpse 330 of interest is scanned when it enters animal preparation station 322-3. Then, upon completing any preparation operations, the tagged animal corpse 330 of interest is scanned again when it exits the animal preparation station 322-3. With each scan event, the electronic record of the tagged animal corpse 330 of interest is updated at tracking data 114 at application server 110.

The ID information of the tagged animal corpse is processed at the alkaline hydrolysis process and the electronic record of the tagged animal corpse is updated (block 525). For example and referring to FIG. 3, the RFID tag 132 of the tagged animal corpse 330 of interest is scanned when it enters alkaline hydrolysis process 322-4. Then, upon completing the alkaline hydrolysis process, the tagged animal remains 330 of interest is scanned again when it exits the alkaline hydrolysis process 322-4. With each scan event, the electronic record of the tagged animal remains 330 of interest is updated at tracking data 114 at application server 110.

The ID information of the tagged animal remains is processed at the animal remains post-processing station and the electronic record of the tagged animal corpse is updated (block 540). For example and referring to FIG. 3, the RFID tag 132 of the tagged animal remains 330 of interest is scanned when it enters the animal remains post-processing station 322-5. Then, upon completing any post-processing, the tagged animal remains 330 of interest is scanned again when it exits the animal remains post-processing station 322-5. With each scan event, the electronic record of the tagged animal remains 330 of interest is updated at tracking data 114 at application server 110.

The ID information of the tagged animal remains is processed at the animal remains storage and the electronic record of the tagged animal corpse is updated (block 545). For example and referring to FIG. 3, the RFID tag 132 of the tagged animal remains 330 of interest is scanned when it enters animal remains storage 322-6. Then, upon exiting animal remains storage 322-6, the tagged animal remains 330 of interest is scanned again. With each scan event, the electronic record of the tagged animal remains 330 of interest is updated at tracking data 114 at application server 110.

The final electronic record of the tagged animal corpse of interest is logged (block 550). For example and referring to FIG. 3, the final electronic record of the tagged animal remains 330 of interest is logged in tracking data 114 at application server 110.

Method 500 shown in FIG. 11 is not limited to process steps with respect to animal pickup vehicle 322-1, animal receiving station 322-2, animal preparation station 322-3, alkaline hydrolysis process 322-4, animal remains post-processing station 322-5, and animal remains storage 322-6 only. These process steps 322 are exemplary only. Other process steps 322 (e.g., process steps 322-1 through 322-n) are possible.

In summary and referring now again to FIG. 1 through FIG. 11, the alkaline hydrolysis tracking system 100 and method 200 in accordance with some embodiments of the present inventive concept is suitable for use in any alkaline hydrolysis process, such as, but not limited to, tracking human remains through alkaline hydrolysis cremation, tracking animal remains through alkaline hydrolysis cremation, tracking biomedical waste being sterilized and disposed through alkaline hydrolysis, and tracking biomedical waste being disposed through alkaline hydrolysis tissue digesters.

In some embodiments, the alkaline hydrolysis tracking system 100 and method 200 provide a durable and electronically readable ID device, such as RFID tag 132 that may be applied to or accompany the biological matter being processed.

In some embodiments, the alkaline hydrolysis tracking system 100 and method 200 provide RFID readers 124 for automatically scanning the RFID tags 132 and wherein the RFID readers 124 are provided along any and/or all steps of the alkaline hydrolysis process, such as alkaline hydrolysis process 120.

In some embodiments, the alkaline hydrolysis tracking system 100 and method 200 provide RFID readers 124 for scanning the RFID tags 132. An electronic record may be automatically created from the collection of identification information. A user interface, such as mobile application 152, may be provided for viewing the identification information about the biological matter being processed.

In some embodiments, the alkaline hydrolysis tracking system 100 and method 200 provide RFID readers 124 for scanning the RFID tags 132. An electronic record may be automatically created from the collection of identification information and used to track and create a validated chain of custody of the biological matter throughout the process.

In some embodiments, the alkaline hydrolysis tracking system 100 and method 200 provide an animal cremation tracking system 300 including the alkaline hydrolysis cremation process 320 for tracking an animal corpse throughout the alkaline hydrolysis cremation process 320.

In some embodiments, methods for tracking a biological material during an alkaline hydrolysis process are provided including collecting identification information from an electronically readable identification device that is applied to or accompanies a biological material of interest; creating an electronic record of the collected information; and optionally viewing and/or storing the collected information on a visual and/or storage medium.

In some embodiments, the electronically readable identification device may be an RFID tag.

In some embodiments, the electronic record may be automatically created from the collection of identification information.

In some embodiments, a user interface may be provided for viewing the identification information about the biological matter being processed. In certain embodiments, the user interface may be a mobile application.

In some embodiments, an RFID reader may automatically scan the electronically readable identification device and wherein the RFID reader is provided along any and/or all steps of the alkaline hydrolysis process.

In some embodiments, the electronic record may be used to create a validated chain of custody of the biological material throughout the alkaline hydrolysis process.

In some embodiments, the method of tracking may be suitable for use in tracking human and/or animal remains through alkaline hydrolysis cremation, tracking biomedical waste being sterilized and disposed through alkaline hydrolysis, tracking biomedical waste being disposed through alkaline hydrolysis tissue digesters, and the like.

In some embodiments, the biological material may be selected from the group consisting of human and animals, including, but not limited to, parts thereof, tissues, organs, blood, bodily fluids, clinical specimens; pathogenic microorganisms (including human, animal, or plant pathogens); plants; insects; microorganisms, or cells that produce toxic compounds; recombinant or synthetic DNA/RNA (plasmids, cloned materials, oligonucleotides, siRNA); viral vectors (e.g., lentivirus, retrovirus, adenovirus, AAV); genetically-modified organisms (animals, microorganisms, plants, insects, cells/cell lines) and waste products thereof; and blood and blood products; pathological waste; cultures and stocks of infectious agents and associated biologicals, contaminated animal carcasses and bedding; biotechnology by-product effluents (i.e., recombinant DNA, vectors, etc.); and chemicals or radiological materials mixed therewith.

In some embodiments, the biological material may be human or animal remains.

In some embodiments, the present inventive concept provides an alkaline hydrolysis tracking system and method for tracking materials in alkaline hydrolysis processes.

In further embodiments, the alkaline hydrolysis tracking system and method is suitable for use in any alkaline hydrolysis process, such as, but not limited to, tracking human remains through alkaline hydrolysis cremation, tracking animal remains through alkaline hydrolysis cremation, tracking biomedical waste being sterilized and disposed through alkaline hydrolysis, and tracking biomedical waste being disposed through alkaline hydrolysis tissue digesters.

In some embodiments, the alkaline hydrolysis tracking system and method provide a durable and electronically readable identification (ID) device, such as a radio-frequency identification (RFID) tag that may be applied to or accompany the biological matter being processed.

In some embodiments, the alkaline hydrolysis tracking system and method provide reader devices for automatically scanning the electronically readable ID device, such as an RFID tag, and wherein the reader devices are provided along any and/or all steps of the alkaline hydrolysis process.

In some embodiments, the alkaline hydrolysis tracking system and method provide reader devices for scanning the electronically readable ID device, such as an RFID tag, and wherein an electronic record may be automatically created from the collection of identification information and wherein a user interface may be provided for viewing the identification information about the biological matter being processed.

In some embodiments, the alkaline hydrolysis tracking system and method provide reader devices for scanning the electronically readable ID device, such as an RFID tag, and wherein an electronic record may be automatically created from the collection of identification information and used to track and create a validated chain of custody of the biological matter throughout the process.

In some embodiments, the alkaline hydrolysis tracking system and method provide an animal cremation tracking system including an alkaline hydrolysis cremation process for tracking an animal corpse throughout the alkaline hydrolysis.

In still other embodiments, the present inventive concept includes an enclosure device used to house the tracking mechanism and capable of progressing through an alkaline hydrolysis process with minimal, if any, destruction. In some embodiments, the enclosure device may include a biomaterial retrieved from the subject's remains. In further embodiments, the enclosure device may include a portion of the subject's remains.

In particular embodiments, the enclosure device may be provided to family, relatives, friends, pet owners or other parties of interest after completion of the alkaline hydrolysis process completing the validated chain of custody.

Although the foregoing subject matter has been described in some detail by way of illustration and example for purposes of clarity of understanding, it will be understood by those skilled in the art that certain changes and modifications can be practiced within the scope of the appended claims.

1. A method for tracking biological material to ensure proper identification of the biological material after undergoing an alkaline hydrolysis process, the method comprising:
associating biological material with a readable electronic mechanism that includes unique identification information associated with the biological material, the readable electronic mechanism being provided to withstand the alkaline hydrolysis process;
performing the alkaline hydrolysis process on the biological material;
obtaining the unique identification information associated with the biological material at at least one point during the alkaline hydrolysis process using a reader configured to communicate with the readable electronic mechanism;
updating a unique electronic record associated with the biological material after obtaining the unique identification information associated with the biological material; and
making the unique electronic record associated with the biological material available to users upon request for information related to the biological material.

2. The method of claim 1:
wherein obtaining the unique identification information associated with the biological material comprises obtaining the unique identification information associated with the biological material multiple times during the alkaline hydrolysis process; and
wherein updating is followed by determining if the alkaline hydrolysis process is complete and repeating the obtaining and updating until it is determined that alkaline hydrolysis process is complete.

3. The method of claim 2, wherein determining if the alkaline hydrolysis process is complete is followed by storing a final electronic record associated with the biological material.

4. The method of claim 1, wherein the readable electronic mechanism is provided to withstand the alkaline hydrolysis process by one of providing a protective coating around the readable electronic mechanism and providing the readable electronic mechanism inside an enclosure such that the readable electronic mechanism withstands the alkaline hydrolysis process.

5. The method of claim 1, wherein associating biological material with a readable electronic mechanism comprises one of attaching the readable electronic mechanism to the biological material or positioning the readable electronic mechanism close to the biological material being processed.

6. The method of claim 1, wherein associating biological material with a readable electronic mechanism is preceded by positioning the biological material in a semi-permeable enclosure before performing the alkaline hydrolysis process and wherein the readable electronic mechanism is also positioned in the semi-permeable enclosure.

7. The method of claim 1, wherein the readable electronic mechanism comprises a radio-frequency identification (RFID) tag.

8. The method of claim 1, wherein the biological material comprises human remains, animal remains, and/or biomedical waste.

9. The method of claim 1, wherein the unique identification information comprises a unique ID number; information about the biological material; information about an owner of the biological material; information about origination of the biological material; and/or information about type of biological material.

10. The method of claim 1, wherein making the unique electronic record associated with the biological material available to users upon request for information related to the biological material comprises providing a graphical user interface that allows users to obtain information from the unique electronic record associated with the biological material before, during and after the alkaline hydrolysis process.

11. A system for tracking biological material to ensure proper identification of the biological material after undergoing an alkaline hydrolysis process, the system comprising:
a readable electronic mechanism that is associated with biological material, the readable electronic mechanism including unique identification information associated with the biological material and configured to withstand the alkaline hydrolysis process;
a reader that obtains the unique identification information associated with the biological material at at least one point during an alkaline hydrolysis process, the reader being configured to communicate with the readable electronic mechanism to obtain the unique identification information;
a server configured to update and store a unique electronic record associated with the biological material after obtaining the unique identification information associated with the biological material; and
a communication device, remote from the server that accesses the unique electronic record associated with the biological material upon request for information related to the biological material.

12. The system of claim 11:
wherein the reader further obtains the unique identification information associated with the biological material multiple times during the alkaline hydrolysis process;
wherein the server repeatedly updates and stores the unique electronic record until it is determined that the alkaline hydrolysis process is complete; and
wherein, when it is determined that the process is complete, the server is configured to store a final electronic record associated with the biological material.

13. The system of claim 11, further comprising one of a protective coating around the readable electronic mechanism and an enclosure that is configured to have the readable electronic mechanism positioned therein, wherein presence of the coating and use of the enclosure ensures that the readable electronic mechanism withstands the alkaline hydrolysis process.

14. The system of claim 13, wherein the enclosure comprises a cameo that includes the readable electronic mechanism therein.

15. The system of claim 14, wherein the cameo further includes a microchip associated with the biological material and/or a portion of the biological material after the alkaline hydrolysis process is complete.

16. The system of claim 13, wherein the enclosure comprises one or more of graphite, carbon black and polymer fibers with base polymers.

17. The system of claim 11, further comprising a semi-permeable enclosure that receives the biological material and the readable electronic mechanism before the alkaline hydrolysis process is performed.

18. The system of claim 11, wherein the readable electronic mechanism comprises a radio-frequency identification (RFID) tag and wherein the biological material comprises animal and/or human remains.

19. The system of claim 11, wherein the unique identification information comprises a unique ID number; information about the biological material; information about an owner of the biological material; information about origination of the biological material; and/or information about type of biological material.

20. The system of claim 11, wherein the communications device comprises a graphical user interface that allows users to obtain information from the unique electronic record associated with the biological material before, during and after the alkaline hydrolysis process.
